(19) United States
(12) Patent Application Publication
(10) Pub. No.: US 2006/0246178 A1
(43) Pub. Date: Nov. 2, 2006

(54) Fermented milk product comprising tripeptide vpp and/or ipp

(76) Inventors: René Bernardus Draaisma, Viaardingen (NL); Mettina Maria G. Koning, Vlaardingen (NL); Adrianus Marinus Ledeboer, Vlaardingen (NL); Johannes Schalk, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/541,477

(22) PCT Filed: Dec. 3, 2003
(86) PCT No.: PCT/EP03/13644

§ 371 Date: Jul. 6, 2005

(30) Foreign Application Priority Data
Jan. 6, 2003 (EP) 03075017.8

(51) Int. Cl. A23C 9/12

(52) U.S. Cl. 426/34

(57) ABSTRACT

The invention relates to a fermented milk product comprising an amount of tripeptides VPP and/or IPP expressed as equivalent IPP concentration [IPPeq] of 145 ?M or more comprising 40-600 mmol/kg K+ and/or 30-400 mmol/kg Ca2+ and/or 6-50 mmol/kg Mg2+.

### FIELD OF THE INVENTION

The invention relates to a fermented milk product comprising tripeptide VPP and/or IPP. The invention further relates to a process for the preparation of such fermented milk product and to food products produced using the fermented milk product.

### BACKGROUND TO THE INVENTION

Hypertension or high blood pressure is considered to be one of the main risk factors for Cardio Vascular Diseases (CVD). One of the mechanisms which regulates blood pressure is the renin-angiotensin system. This is a cascade of reactions leading to the formation of angiotensin II, which has a strong vasoconstrictive and hence blood pressure-increasing effect. Inhibition of one of the key enzymes in this cascade: Angiotensin I Converting Enzyme (ACE) reduces formation of angiotensin II and thus has a blood pressure lowering effect. Long term human intervention studies have shown regular intake of low amounts of ACE inhibitors reduces CVD by 25% (Gerstein et al. (2000), The Lancet 355, 253-259).

A commercially available fermented milk product, which claims to be “suitable for those with mild hypertension” is Calpis sour milk, fermented with Lactobacillus helveticus and Saccharomyces cervisiae, produced by Calpis Food Industry, Japan.

Another commercially available fermented milk product is Evolus produced by Valio, Finland, which claims to be ‘the first European functional food to help lower blood pressure’.

Both fermented milk products are fermented with Lactobacillus helveticus (Lb. helveticus) strains. The products contain bio-active peptides responsible for in vitro ACE inhibition, which are produced by proteolysis of caseins. Compared to other lactic acid bacteria Lb. helveticus is one of the most efficient proteolytic Lactobacillus species.

The breakdown of caseins by the proteolytic system of lactic acid bacteria can be divided into three stages. Initially breakdown of casein is performed by extracellular proteinases, followed by the uptake of di/tri peptides and oligopeptides (4 to 12 amino acidic residues) using specific uptake mechanisms. In the last stage, peptides are further degraded by intracellular peptidases, yielding small peptides and amino acids for bacterial growth. This complicated proteolytic system of lactic acid bacteria is described in Kunji et al., (1996), Molecular Microbiology 27, 1107-1118. A review on the intracellular peptidase system can be found in Christensen et al., (1999), Molecular Microbiology 76, 217-246.

EP-A-0737690 describes an antihypertensic agent comprising an effective amount of peptides containing an aminoacid sequence Lys Val Leu Pro Val Pro Gln and/or Tyr lys Val Pro Gln Leu and a process for preparing such an agent using a proteinase produced by lactic acid bacteria. On page 3, it is described that in order to increase the yield of targeted proteinase the pH should be in neutral range, that is in a range of 5 to 8.

According to EP-A-1016709, it is desired to produce fermented milk with higher content of the lactotripeptides compared to the content of the lactic acid generated in the fermented milk. It provides a Lactobacillus helveticus strain CM4 that in fermentation gives 30-50 μg of tripeptides Val-Pro-Pro (VPP) and Ile-Pro-Pro (IPP) per 0.01 g of DL-lactic acid. In table 2 of EP-A-1016709 it is shown that this strain produced 38.5 μg/ml whey of VPP and 23.5 μg/ml whey IPP, which corresponds to an IPPeq value, as defined hereinafter, of 140 μM.

### SUMMARY OF THE INVENTION

It is an object of the invention to provide a fermented milk product having a high content of tripeptides VPP and/or IPP. It is another object of the invention to provide a fermented milk product, that when used in a food product, has a good taste. It is still another object of the invention to provide a fermented milk product that shows an improved blood pressure lowering effect.

One or more of these objects are attained according to the invention, which provides a process for the preparation of a fermented milk product, wherein fermentation is controlled by addition of a base in such an amount that the pH during a substantial part of the fermentation is 4.3-5.9.

The invention further relates to a fermented milk product comprising an amount of tripeptides VPP and/or IPP expressed as equivalent IPP concentration [IPPeq] of 145 μM or more, obtainable according to the process of the invention, comprising 40-600 mmol/kg K⁺ and/or 30-400 mmol/kg Ca²⁺ and/or 6-50 mmol/kg Mg²⁺.

### DETAILED DESCRIPTION OF THE INVENTION

The amounts given will be expressed relative to the total weight of the food product or fermented milk product, unless otherwise indicated.

Lactobacillus is herein abbreviated as Lb.

The peptide Val-Pro-Pro is abbreviated as VPP and the peptide Ile-Pro-Pro as IPP.

Tripeptides VPP and/or IPP as defined herein include VPP, IPP and peptides containing 3-25 amino acid residues including the sequence VPP and/or IPP, and mixtures of these peptides. The total molar amount of tripeptides VPP and/or IPP in mixtures are herein calculated by addition of molar amounts of the tripeptides in the mixture.

The fermentation according to the invention produces the active tripeptides VPP and IPP, which have a different activity. The IC₅₀, the concentration which results in 50% inhibition of the ACE activity, is 5 μM for IPP and 9 μM for VPP (Kohmura, M. et al. (1990), Agricultural and Biochemical Chemistry, 54, 835-836 and Nakamura, Y. et al. (1995), J. Dairy Sci. 78, 1253-1257). To express the overall concentration of these active peptides in a single FIGURE, the equivalent IPP concentration ([IPPeq] is used herein, which is defined as follows, and preferably expressed in μM:
[IPPeq]=[IPP]+ 5/9*[VPP] (1)

Food products according to the invention are defined as products, suitable for human consumption, in which a fermented milk product according to the invention was used as an ingredient in an effective amount, such that a noticeable ACE-inhibitory effect is obtained.

The milk starting material may be any milk, as long as it contains a protein comprising the amino acid sequence VPP and/or IPP. Animal milk such as cow's milk, goat's milk, camel milk, horse's milk, may be used as a milk starting material. Skim milks may be used. The content of the solid in the milk starting material is not particularly limited, but is usually 5 to 20 wt %. The milk starting material may be reconstituted milk, prepared by mixing water and milk ingredients, for instance (skim) milk powder. The milk starting material may contain additives, such as carbohydrates, etc. as long as these additives do not interfere with the fermentation.

Fermentation of the milk starting material may be executed in conventional fermentors, in which the milk starting material as a medium is inoculated with the Lb. helveticus.

The Lb. helveticus may be any Lb. helveticus strain. Preferred are those strain that produce high amounts of tripeptide VPP and/or IPP. Most preferred is Lactobacillus helveticus strain CNRZ 244, deposited at Centre National de Recherches Zootechniques, Jouy-en-Josas, France.

Other microorganisms may optionally be added to the fermentation medium as long as the object of the present invention is achieved. For example, yeast may additionally be used for improving the flavor and palatability of the resulting fermented milk product.

Strains of the yeast are not particularly limited, and for example, yeast of the genus Saccharomyces such as Saccharomyces cerevisiae may preferably be used. The content of the yeast may suitably be selected, depending on the desired result.

There is no particular limitation on the amount of the Lb. helveticus with which the medium is inoculated. The inoculation amount is usually about 10⁷ to 10⁹ cells of the Lb. helveticus bacteria.

The Lb. helveticus may be added to the fermentation preferably in the form of a precultured starter having sufficient activity. The initial cell count of the starter is preferably about 10⁷ to 10⁹ cells/ml.

The materials in the fermentor, including Lb. helveticus inoculum and the milk starting material, may be mixed in conventional way, in order to achieve a homogeneous fermentation medium.

The fermentation advantageously may be performed at 25 to 50° C. and preferably 30 to 45° C., for 6 to 100 hours and preferably 15 to 50 hours. Preferably the fermentation temperature is 38-42° C., since in this temperature range the highest amount of tripeptides VPP and/or IPP is formed.

We have found that the pH during fermentation is critical as to the amount of tripeptides VPP and/or IPP formed. Preferably therefore, the fermentation is controlled by addition of a base in such an amount that the pH during a substantial part of the fermentation is 4.3-5.9. The pH during a substantial part of the fermentation is 4.3-4.9, more preferably 4.4-4.8 and most preferably 4.5-4.7. A substantial part of the fermentation means in this context at least 1 hour or more of the fermentation time. Preferably the pH of during fermentation is controlled during 3 hours or more of the fermentation time, more preferably 5 hours or more.

The pH may be controlled by addition of base (or buffer) to the fermentation medium. The base may be any base suitable for use in the preparation of food products. Such controlled fermentation is herein called pH-controlled fermentation. Without pH-control is herein called free acidification fermentation.

Preferably, the base has K⁺ ions and the pH during a substantial part of the fermentation is 4.9-5.5. Alternatively, in a preferred embodiment, the the base has Ca²⁺ ions and the pH during a substantial part of the fermentation is 4.3-4.9. A combination of base containing the ions K⁺, Ca²⁺ and/or Mg²⁺ is especially preferred.

During the fermentation, Lb. helveticus produces amongst others lactic acid. Lactic acid (HLa or LaH) dissociates into a proton, H+, and a lactate anion, La− (sometimes referred to herein as dissolved lactate salt when another source of cation is present, typically from the base or buffer salt). The amount of dissociation is related to the pH of the solution and the PKa of lactic acid. The pKa of lactic acid at 25° C. is 3.86 (at 50° C. it is about 3.89). Equation (2) below describes how the pH, pKa, and degree of lactic acid dissociation are related.
pH=pKₐ+log([La⁻]/[LaH]) (2)
Equation (2) shows that half the acid is dissociated when the pH equals the pKa of the acid. At higher pH values, the majority of the lactic acid is in the lactate anion form. If the fermentation broth has a pH value between 3.0 and 4.5, there will be a significant amount of lactic acid in the undissociated form. Indeed at a pH of 3.0 the molar ratio of free lactic acid (undissociated) to lactate ion at 25° C. is about 7.0; and, at a pH of about 4.5 the ratio at 25° C., is about 0.23.

A preferred protocol for pH-controlled fermentation is executed as follows: After inoculation (1) a free acidification fermentation until the desired pH is reached (in range 4.3-4.9), subsequently (2) a pH-controlled fermentation and optionally (3) subsequently a second free acidification fermentation until the termination, e.g. at pH 3.5-4.0. As result of this protocol a high amount of equivalent IPP can be produced, while maintaining a relatively low level of salts in the fermented milk product.

Preferably the base is a metal salt, the metal of which is common in food, but does not increase the blood pressure. Preferably the base is a hydroxide. A base containing sodium, such as sodium hydroxide, is therefore preferably excluded. More preferably the base is a salt chosen from the group consisting of calcium salt, potassium salt and/or magnesium salt. The metal ions of such a base K^{+′} Ca²⁺ and/or Mg²⁺, which as a result of the pH-controlled fermentation will become part of the fermented milk product, may decrease the blood pressure in humans.

Preferably the level of dissolved oxygen (dO₂) during fermentation is 5% or less. At low dissolved oxygen levels the production of tripeptides VPP and/or IPP is increased, compared to higher oxygen levels. The fermentor may be sparged and/or the headspace of the fermentor may be flushed, with an inert gas, such as nitrogen in order to accomplish low dissolved oxygen levels.

Advantageously, after termination of the fermentation, several additional process steps may be executed. For instance, solid calcium lactate and/or magnesium lactate may be separated from the fermented milk, e.g. by cooling the fermented milk product, such that these lactates precipitate. The fermented milk product may be used as such, or may be diluted, it may be concentrated, it may be purified and it may be dried, preferably spray-dried or freeze-dried.

According to the invention a relatively high number of VPP and/or IPP molecules may be liberated from the casein containing starting material (the substrate). Preferably, the molar yield of VPP on its substrate is 15% or more, preferably 20% or more and more preferably 25% or more. The molar yield of VPP is defined as the molar amount of VPP produced in the fermentation divided by the molar amount of VPP fragments in the total mass of casein present in the milk starting material prior to the start of fermentation. An analogous calculation gives the molar yield of IPP. The molar yield of IPP is preferably 8% or more, more preferably 10% or more and most preferably 25% or more.

With the process of the invention, a fermented milk is obtainable, which comprises an amount of tripeptides VPP and/or IPP expressed as equivalent IPP concentration [IPPeq] of 145 μM or more.

The fermented milk product comprises 40-600 mmol/kg K⁺ and/or 30-400 mmol/kg Ca²⁺ and/or 6-50 mmol/kg Mg²⁺ preferably, 50-600 mmol/kg K⁺ and/or 40-400 mmol/kg Ca²⁺ and/or 8-50 mmol/kg Mg²+, more preferably 100-150 mmol/kg K⁺ and/or 40-100 mmol/kg Ca²⁺ and/or 10-25 mmol/kg Mg²⁺ and most preferably 110-135 mmol/kg K+ and/or 40-60 mmol/kg Ca²⁺ and/or 13-20 mmol/kg Mg²⁺. The levels of these ions herein will be determined as K, Ca and Mg, i.e. irrespective of ion charge. Preferably, the fermented milk product comprises two or more of the above mentioned ions K⁺, Ca²⁺ and Mg²⁺ in the amounts mentioned above, more preferably all three of these ions in the mentioned amounts.

The fermented milk product or products derived therefrom, may be consumed as such by human beings. They may also be used in a food product as a food ingredient. Preferably, in such case the levels of equivalent IPP concentration and K⁺, Ca²⁺ and Mg²⁺ of the food product are within the ranges as defined herein for the fermented milk product.

The fermented milk product according to the invention or food products derived therefrom may be pasteurized or sterilised.

The food products according to the invention may be of any food type. They may comprise common food ingredients in addition to the fermented milk product, such as flavour, sugar, fruits, minerals, vitamins, stabilisers, thickeners, etc. in appropriate amounts. Preferably the food products are dairy type products or frozen confectionary products. These preferred types of food products are described in some detail below and in the examples.

Dairy Type Products

Examples of dairy products according to the invention are milk, dairy spreads, cream cheese, milk type drinks and yogurt, wherein the milk solids are partly or fully consisting of solids from Lb. helveticus fermented milk.

An example of a composition for a yoghurt type product is about 50-80 wt. % water, 3-12 wt. % Lb. helveticus fermented milk solids, 0-15 wt. % whey powder, 0-15 wt. % sugar (e.g. sucrose), 0.01-1 wt. % yoghurt culture, 0-15 wt. % fruit, 0.05-5 wt. % vitamins and minerals, 0-2 wt. % flavour, 0-5 wt. % stabilizer (thickener or gelling agent).

A typical serving size for a yogurt type product could be from 50 to 250 g, generally from 80 to 200 g.

Frozen Confectionery Products

For the purpose of the invention the term frozen confectionery product includes milk containing frozen confections such as ice-cream, frozen yogurt, sherbet, sorbet, ice milk and frozen custard, water-ices, granitas and frozen fruit purees.

Preferably the level of solids in the frozen confection (e.g. sugar, fat, flavouring etc) is more than 3 wt. %, more preferred from 10 to 70 wt. %, for example 40 to 70 wt. %.

Ice cream will typically comprise 0 to 20 wt. % of fat, 2 to 20 wt. % fermented milk solids, sweeteners, 0 to 10 wt. % of non-fat milk components and optional components such as emulsifiers, stabilisers, preservatives, flavouring ingredients, vitamins, minerals, etc, the balance being water. Typically ice cream will be aerated e.g. to an overrun of 20 to 400%, more specific 40 to 200% and frozen to a temperature of from −2 to −200° C., more specific −10 to −30° C. Ice cream normally comprises calcium at a level of about 0.1 wt %.

Other food product according to the invention can be prepared by the skilled person based on common general knowledge, using fermented milk or fermented milk derived products as an ingredient in suitable amounts. Examples of such food products are baked goods, dairy type foods, snacks, drinks etc.

Advantageously the food product is an oil and water containing emulsion, for instance a spread. Oil and water emulsion is herein defined as an emulsion comprising oil and water and includes oil in water (O/W) emulsions and water in oil emulsions (W/o) and more complex emulsions for instance water-in-oil-in-water (W/O/W/O/W) emulsions. Oil is herein defined as including fat.

Preferably the food product is a drink, especially a dairy type drink, a spread, frozen confection, or sauce.

Preferably a spread according to the invention comprises 30-90 wt. % vegetable oil. Advantageously a spread has a pH of 4.2-6.0.

### EXPLANATION OF THE DRAWINGS

FIG. 1

FIG. 1 shows the concentration of VPP, IPP and calculated IPPeq (in μM) according to examples 1-8 as function of the pH. IPP data are indicated by ▴, and VPP data by ● and IPPeq data are indicated by ♦.

FIG. 2

FIG. 2 shows typical pH profiles. The pH is plotted as function fermentation time (in hours). The short curve shows free acidification fermentation of 24 hours with a pH-controlled phase at 10-15 hours and the long curve fermentation without pH-control for 48 hours.

FIG. 3

FIG. 3 shows the concentration of formed ACE inhibiting peptides VPP and IPP expressed in μM as function of fermentation time (in hours). VPP data are shown as ● and IPP data as ▴. The data for example 16 are connected by a solid line and those of example 17 with a dotted line.

### EXAMPLES

Determination of Amounts of IPP and VPP

Quantification of VPP and IPP was performed using HPLC-MRM-MS in positive ESI mode. The samples were analysed using a HP1100 (ex Agilent) HPLC system combined with

a Quattro-II triple quadrupole mass spectrometer (ex Micromass UK). The samples were injected on a Varian 150×2.1 mm Inertsil ODS-3 column prepacked by GL_Sciences. The eluent gradient was linear from 100% water containing 0.1% trifluoric acid (TFA) to 100% of acetonitrile containing 0.1% of TFA in 46 minutes with a flow rate of 0.2 ml/min. The ion source of the MS was operating in positive-electrospray mode. The daughter ion m/z 213.1 was monitored in MRM of the parent ions m/z 12.2 and m/z 326.2 of VPP and IPP respectively. The cone voltage was 19V and the collision energy 18 eV for both compounds. The collision gas used was Argon, and the collision gas pressure was 2.3×10−3 mbar. The quantification was performed suing a separate external calibration curve for both compounds.

Determination of ACE Inhibition Activity

The ACE inhibition activity was determined using an assay technique described hereunder. In this in vitro assay the internally quenched fluorogenic substrate Abz-FRK(Dnp)P—OH described by Araujo M. C. et al, Biochemistry 39, 8519-8525 (2000), is used.

When ACE cleaves the R—K bond of the fluorogenic substrate, the distance of the quencher (Dnp) with regard to the fluorescent group (Abz) will be enlarged resulting in a fluorescent signal.

This signal is direct related to the ACE activity and is measured with a fluorometer.

Samples were prepared as follows:

The fermented milk was transferred to a centrifuge tube. The pH was adjusted to 4.0±0.1 by adding a few μl of 6 M HCl and centrifuged for 5-10 minutes at 4.000×g at room temperature (RT). The supernatant was transferred to a tube and the pH was adjusted to 7.0±0.1 by adding a few μl of 6 M NaOH. The pH-adjusted sample was transferred to an Eppendorf tube and centrifuged for ten minutes at 14.000 rpm at RT. The supernatant was transferred to a tube and ready for the ACE inhibition activity assay. If sample was not processed immediately, it was stored at −20° C.

150 μl 3.75 μM Abz-FRK(Dnp)P—OH in assay buffer (=100 mM Tris buffer (with 100 mM NaCl) pH 7.0)+20 μl 0.00625 U/ml ACE in assay buffer+40 μl sample/assay buffer were added per well to a microplate, the activity of the ACE was then followed directly using fluorescence (λₑₓ: 320 nm λₑₘ: 420 nm). The slope/second is a measure for the activity of ACE.

As a standard, Captopril (1 nM end-concentration) or IPP (5 μM end-concentration) was used. Both concentrations gave about 30% inhibition of the ACE activity.

The ACE inhibition (ACEI) is expressed as arbitrary units (a.u.), which is defined as follows:
ACE inhibition (a.u.)=ACEI (%)*Dilution (3)
ACEI (%)=(1−(A−B)/(C−B))*100 (4)
A=value of the sample
B=value of the blank, no ACE nor inhibitor
C=Value of control, ACE and no inhibitor
Proteolytic Activity

The presence of the total amount of amino groups, as free amino acids, peptides and proteins in fermented milk samples is used to evaluate the proteolytic activity (proteolysis) of the lactic acid bacteria. A method to determine a degree of hydrolysis in food protein hydrolysates described by Adler-Nissen J. in Agric. Food Chem. 27, 1256-1262 (1979) was used.

5 μL of sample, leucine standard (0.25-2.5 mM) or distilled water were added to 40 μL of 0.21 M phosphate buffer pH 8.2 and 40 μL of 0.1 wt % TNBS solution, followed by incubation in the dark for 60 minutes at 50° C. The reaction is quenced by adding 80 μL of 0.1 M HCl. Absorbance was meased at 340 nm (Adler-Nissen J. Enzymatic hydrolysis of food proteins. New York: Elsevier Applied Science Publishers p. 110-169).

The total amount of amino groups present in the milk was expressed as mM Leucine equivalents.

Metal concentrations of Ca and Mg were measured using an Inducive Coupled Plasma (ICP)—Plasma Emission Spectrometry and metal concentrations of Na and K were measured using a Flame Atomic Absorption Spectrometry (FAAS).

### Comparative Examples A-I

Preculture-1 Preparation:

Sterile skim milk (Yopper ex Campina, Netherlands) was inoculated for 24 hours at 37° C. with 2 to 4% of a culture of a Lactobacillus helveticus strain of table 1, that had been stored at −80° C. as a full grown culture in the above described skim milk, diluted with sterile 10% glycerol to an end concentration of 6% glycerol. The resulting product is designated as preculture-1.

For comparative examples A-I, sterile skimmed milk (Yopper ex Campina, Netherlands) was fermented with 2 wt % of preculture-1 prepared for each different strain as described in pre-culture preparation. The fermentations with the nine different Lactobacillus helveticus strains were stirred and performed without pH control under anaerobic conditions at 40° C. Results from the ACE inhibition (ACEI), IPP and VPP formation and the proteolytic activity (proteolysis) of fermentations (repeated twice) are shown table 1 (average data).

TABLE 1
Results of screening of Lb. helveticus
strains in comparative examples A-I:

| | | | Prote- | | | |
|---|---|---|---|---|---|---|
| Example | | | olysis | | | |
| Comp. | | ACEI | (mM leu | IPP | VPP | IPPeq |
| Ex. No. | Strain | (a.u.) | eq) | (μM) | (μM) | (μM) |
| A | CNRZ 244 | 517 | 12 | 36.3 | 33.3 | 55 |
| B | 7 WIESBY | 475 | 4.2 | 11.8 | 13.8 | 19 |
| C | BP 01 | 429 | 4.8 | 9.8 | 7 | 14 |
| D | CNRZ 303 | 392 | 10.5 | 7 | 8.3 | 12 |
| E | ATCC | 364 | 7.3 | 7.3 | 5.8 | 11 |
| | 15009 | | | | | |
| F | ATCC | 325 | 5.9 | 3.3 | 4.3 | 6 |
| | 55796 | | | | | |
| G | CNRZ 32 | 308 | 6.2 | 1 | 2 | 2 |
| H | NCDO 766 | 300 | 8.1 | 15.3 | 17 | 25 |
| I | NCDO 30 | 256 | 4.1 | 1 | 0.5 | 1 |

Explanation of the Strain Origin:
CNRZ: Centre National de Recherches Zootechniques, Jouy-en-Josas, France.
NCDO: National Collection of Dairy Organisms. See: NCFB.
NCFB: National Collection of Food Bacteria (previously named
NCDO) later NCIMB: National Collection of Industrial and Marine Bacteria, National
Collections of Industrial, Food and Marine Bacteria, 23 Machar Drive, Aberdeen, AB24 3RY, Scotland.
ATCC: American Type Culture Collection
Wiesby: Danisco Cultor
BP 1: strain isolated from commercial product Evolus (ex Valio, Finland)

The comparative examples A-I show that of the screened Lb. helveticus strains, the strain CNRZ 244 shows the highest formation of VPP and IPP. Moreover these results show Lb. helveticus CNRZ 244 had a higher ability to form ACE inhibition and a higher proteolytic activity compared to other Lb. helveticus strains.

### Examples 1-8

A preculture (preculture-2) was prepared with sterile skim milk (Yopper, ex Campina, Netherlands), which was inoculated with a preculture-1 of Lactobacillus helveticus CNRZ 244. This preculture was not stirred and incubated for 24 hours at 37° C. The fermentations were conducted by inoculation of the sterile skimmed milk (Yopper) with preculture-2 in a stirred tank reactor (STR) equipped with a six-blade impeller with a bottom drive (Ruston fermentors) having a volume of 3 liters. Stirrer speed was maintained at 150 rpm and dissolved oxygen (dO2) and pH were monitored during fermentation.

Anaerobic conditions (dO2 lower than 5%) were maintained using a headspace flush with nitrogen gas. The pH controlled fermentations were performed with free acidification phase prior to pH control. During fermentation the pH was allowed to decrease till its pH setpoint was reached. Thereafter the pH was controlled using a 10 wt % suspension of calcium hydroxide. After 24 hours of fermentation the calcium levels reached up to 0.4 to 0.6 wt % of the fermented milk.

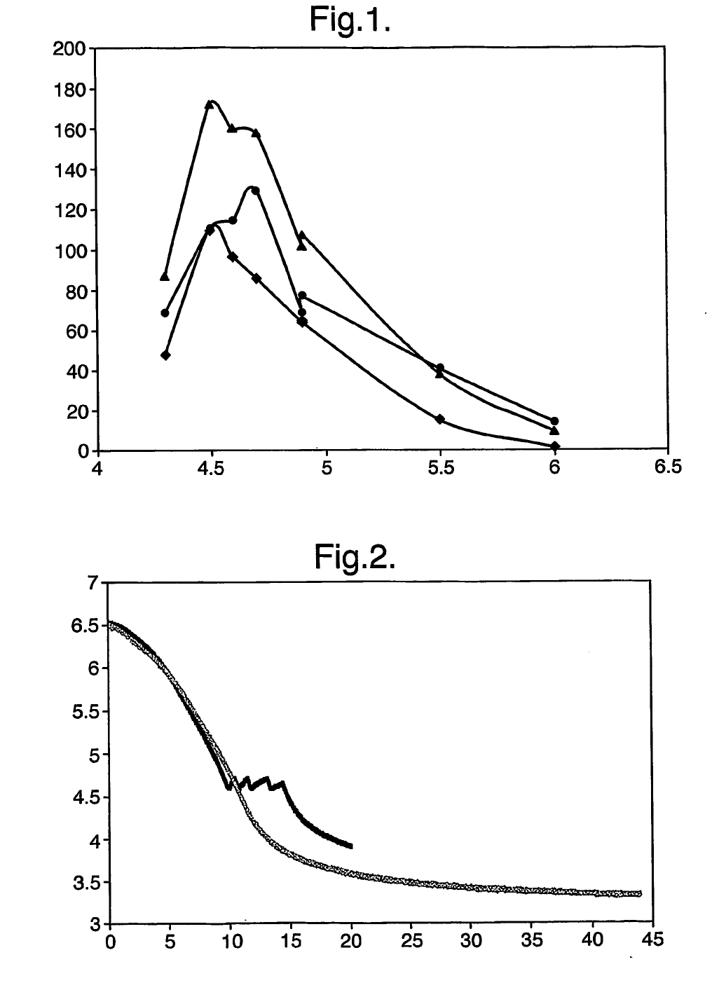

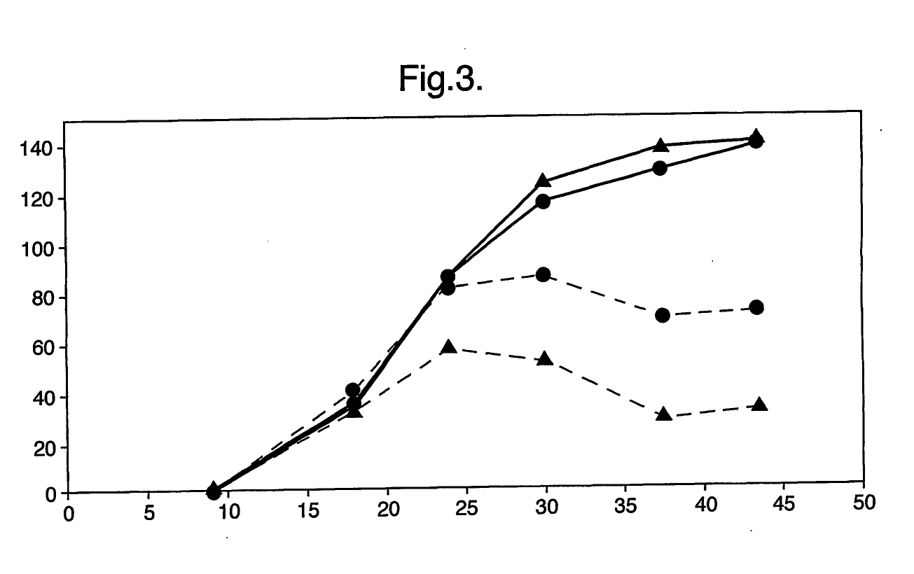

The results are given in table 2 and in FIG. 1.

TABLE 2
Controlled pH fermentation using calcium hydroxide
as base at 24 hours fermentation time.

| | |
|---|---|
| | Molar yield |
| Concentration (μM) | on casein |

| Example | pH | IPP | VPP | IPP eq | IPP | VPP |
|---|---|---|---|---|---|---|
| 1 | 4.3 | 47.8 | 68.8 | 86.0 | 9% | 18% |
| 2 | 4.5 | 110.1 | 110.7 | 171.6 | 20% | 29% |
| 3 | 4.6 | 96.2 | 114.6 | 159.9 | 17% | 30% |
| 4 | 4.7 | 85.8 | 129.0 | 157.5 | 15% | 33% |
| 5 | 4.9 | 63.7 | 69.0 | 102.0 | 11% | 18% |
| 6 | 4.9 | 64.6 | 76.9 | 107.3 | 12% | 20% |
| 7 | 5.5 | 15.0 | 40.5 | 37.5 | 3% | 10% |
| 8 | 6.0 | 1.3 | 13.9 | 9.0 | 0.2% | 4% |

### Examples 9-13

Examples 9-13 were executed as Examples 1-8, but now the fermentation time was 42 to 46 hours instead of 24 hours. Final levels of calcium in the fermented milk reached up to 0.8 wt % (200 mmol/kg). The results are shown in table 3.

TABLE 3
Controlled pH fermentation using calcium hydroxide as
base at 42 to 46 hours fermentation (ferm.) time.

| | Ferm. | | | | | Molar yield | |
|---|---|---|---|---|---|---|---|
| | Time | | Concentration (μM) | | | on casein | |
| Example | (h) | pH | IPP | VPP | IPP eq | IPP | VPP |
| 9 | 42 | 4.3 | 92.8 | 130.6 | 165.4 | 17% | 34% |
| 10 | 42 | 4.5 | 129.4 | 146.9 | 211.0 | 23% | 38% |
| 11 | 42 | 4.7 | 107.2 | 169.6 | 201.4 | 19% | 44% |
| 12 | 46 | 4.9 | 104.6 | 118.5 | 170.4 | 19% | 31% |
| 13 | 46 | 4.9 | 112 | 114 | 175.3 | 20% | 29% |

Examples 1-13 show that by controlling the pH during fermentation in the range of 4.3-4.9, the formation of active tripeptides VPP and IPP released from milk caseins during fermentation is high.

### Example 14

Examples 14 was executed in a 15 liter Rushton fermentor using the conditions as described in Examples 1-8, with different protocols for preculture and pH control during fermentation.

A preculture (preculture-3) was prepared with sterile skim milk (Yopper, ex Campina, Netherlands), which was inoculated with 2 wt % preculture-1 of Lactobacillus helveticus CNRZ 244. Preculture-3 was stirred and incubated at 40° C. for 24 hours under anaerobic conditions, using a headspace nitrogen gas flush.

Skimmed milk was reconstituted by mixing 9 wt % skim milk powder (Promex, ex Coberco, Netherlands) in tap water and sterilised.

The sterile reconstituted milk was fermented with 2 wt % of preculture-3 at 40° C. under anaerobic conditions.

The pH was controlled for a limited time using as a base a mixture of hydroxides containing 3.9 wt % calciumhydroxide and 1.25 M potassium hydroxide as follows (Fermentation protocol A).

During fermentation the pH of the milk was allowed to decrease from pH 6.5 or 6.3 to pH 4.6, during 9 to 11 hours. At pH 4.6 the pH was controlled for 5 to 7 hours, using a base mixture of calciumhydroxide and potassiumhydroxide (A volume of 300 ml containing 3.9 wt % calciumhydroxide and 1.25 M potassium hydroxide was used for 7.5 l fermented milk). After this pH controlled phase the pH was again allowed to decrease to 4.0. The final levels of calcium and potassium in the fermented milk were 0.2 wt % (50 mmol/kg) and 0.29 wt % (74 mmol/kg) respectively. A typical pH-curve for a fermentation comtrolled as in this example 14 is given in FIG. 2.

The results are shown in table 4.

### Comparative Example J

Comparative example J was executed as example 14, but now pH was not controlled (fermentation protocol B).

Fermentation protocol without pH control (free acidification): Preculture-3, sterile reconstituted milk and conditions same as 14 without pH control. After fermentation calcium and potassium were added as lactate salts.

The results are shown in table 4.

TABLE 4
Results of example 14 and comparative example J

| Example | | IPP | VPP | IPP eq |
|---|---|---|---|---|
| Comp. Ex. | Fermentation | (μM) | (μM) | (μM) |
| 14 | Protocol A | 90.2 | 131.2 | 163 |
| J | Protocol B | 60.6 | 88.0 | 109 |

Table 4 shows that controlling pH at pH=4.6 using a mixture of calciumhydroxide and potassium hydroxide increases the production of active peptides VPP and IPP.

### Example 15

Preparation of Fermented Milk Drinks

The fermented milks obtained according to examples 14 and comparative example J were used to produce fermented milk drinks.

The fermented milk drink contained 90 wt % of the original fermented milk and the following ingredients: 5.5 wt % sucrose (ex CSM, Netherlands), 1.5 wt % fructose syrup (ex Sensus, Netherlands), 2 wt % Multifruit fruitpulp (ex Wild, Netherlands), 0.1 wt % yoghurt flavour ZD-49492 (ex Quest, Netherlands), 0.03 wt % fruit flavour 037-00330-11 (ex Givaudan, Switzerland), 0.1 wt % cream flavour U33162 (ex Danisco, Denmark) and 0.8 wt. % Genu pectine YM-115-H (ex CPKelco, Denmark).

After the ingredients were mixed in, the fermented milk drinks were homogenised at 150 bar and pasteurised for 15 seconds at 75° C.

The taste of the milk drink was good.

### Example 16 and 17

Examples 16 and 17 were executed in a Rushton fermentor using the conditions as described in Examples 1-8, with the same protocol for preculture, in stead of calcium hydroxide, potassium hydroxide was used for pH control during fermentation.

The pH was controlled at pH setpoints 5.2 (example 16) and 5.9 (example 17).

The final levels of potassium reached up to 1.6 wt % (average 410 mmol/kg K⁺) of the fermented milk.

### Example 18

Example 8 was executed as Example 14, but the fermentation was started as a free acidified fermentation and once the pH 4.6 was reached, the pH was maintained at this pH by addition of the base mixture during the remaining fermentation time. ??

1. Fermented milk product comprising tripeptides VPP and/or IPP, wherein the fermented milk product comprises an amount of tripeptides VPP and/or IPP expressed as equivalent IPP concentration [IPPeq] of 145 μM or more, characterized in that the fermented milk product comprises 40-600 mmol/kg K⁺ and/or 30-400 mmol/kg Ca²+ and/or 6-50 mmol/kg Mg²⁺.

2. Fermented milk product according to claim 1, wherein the fermented milk product comprises 50-600 mmol/kg K⁺ and/or 40-400 mmol/kg Ca²⁺ and/or 8-50 mmol/kg Mg²+.

3. Fermented milk product according to claim 2, wherein the fermented milk product comprises 100-150 mmol/kg K⁺ and/or 40-100 mmol/kg Ca²⁺ and/or 10-25 mmol/kg Mg²⁺.

4. Fermented milk product according to claim 3, wherein the fermented milk product comprises 110-135 mmol/kg K⁺ and/or 40-60 mmol/kg Ca²⁺ and/or 13-20 mmol/kg Mg²⁺.

5. Process for the preparation of a fermented milk product, wherein fermentation is controlled by addition of a base in such an amount that the pH during a substantial part of the fermentation is 4.3-5.9.

6. Process according to claim 5, wherein the base has. K⁺ ions and the pH during a substantial part of the fermentation is 4.9-5.5.

7. Process according to claim 5, wherein the base has Ca²⁺ ions and the pH during a substantial part of the fermentation is 4.3-4.9.

8. Process according to claim 5 wherein the base comprises K⁺, Ca²⁺ and/or Mg²⁺.

9. Process according to claim 6, wherein the temperature during fermentation is 3842° C.

10. Process according to claim 6, wherein the level of dissolved oxygen (dO₂) during fermentation is 5% or less.

11. Process according to claim 6, wherein the base is a salt chosen from the group consisting of calcium salt, potassium salt and/or magnesium salt.

12. Process according to claim 10, wherein the salt is a hydroxide.

13. Process according to claim 10, wherein after termination of the fermentation solid calcium lactate is separated from the fermented milk.

14. Process according to claim 6, wherein a water-containing product of the fermentation is dried.

15. Process according to claim 13, wherein the water containing product of the fermentation is spray-dried or freeze-dried.

16. Process according to claim 6 wherein the molar yield of VPP on its substrate is 15% or more.

17. Use of Lactobacillus helveticus strain CNRZ 244, deposited at Centre National de Recherches Zootechniques, Jouy-en-Josas, France, for the production of a fermented milk product comprising [IPPeq] of 145 μM or more.


SEQUENCE LISTING (2 sequences)

SEQ ID NO: 1 - protein, 7 aa, Artificial
  Product of hydrolised protein
KVLPVPQ

SEQ ID NO: 2 - protein, 6 aa, Artificial
  Product of hydrolised protein
YKVPQL